(19) United States
(12) Patent Application Publication
(10) Pub. No.: US 2024/0304369 A1
(43) Pub. Date: Sep. 12, 2024

(54) WATERPROOF ELECTROMAGNETIC DEVICE AND PRODUCTION METHOD THEREOF

(71) Applicant: PREMO, S.L., Campanillas (MALAGA) (ES)

(72) Inventors: José Ramón FERNÁNDEZ DE LA FUENTE, Atarfe (Granada) (ES); Claudio CAÑETE CABEZA, Benalmádena (ES); Antonio ROJAS CUEVAS, Málaga (ES); Francisco Ezequiel NAVARRO PÉREZ, Barcelona (ES)

(21) Appl. No.: 18/494,834

(22) Filed: Oct. 26, 2023

(30) Foreign Application Priority Data
Oct. 26, 2022 (EP) 22383032.4

(51) Int. Cl. H01F 27/02; H01F 27/04; H01F 27/26; H01F 41/00

(52) U.S. Cl. CPC H01F 27/022; H01F 27/027; H01F 27/04; H01F 27/266; H01F 41/005

(57) ABSTRACT

A waterproof electromagnetic device and production method thereof, the waterproof electromagnetic device having a magnetic core (10) surrounded by at least one coil (20); an electronic circuit board (30) including at least connection pins (31) electrically connected to the at least one coil (20); and an enclosure (40) overmolded on a waterproof manner surrounding the magnetic core (10), the at least one coil (20) and the electronic circuit board (30); wherein the magnetic core (10) further includes several protrusions (11) projecting from the magnetic core (10) towards an external surface of the enclosure (40), so that a centering of the magnetic core (10) within the enclosure (40) is provided during the overmoulding operation.

### CROSS-REFERENCE TO RELATED APPLICATION

This application claims priority of European Patent Application No. 22383032.4, filed Oct. 26, 2022, the contents of which is incorporated herein by reference.

### TECHNICAL FIELD

The present application is directed towards a waterproof electromagnetic device comprising a magnetic core surrounded by at least one coil connected to connection pins of an electronic circuit board, the magnetic core, the surrounding at least one coil and the electronic circuit board being embedded in an enclosure overmolded there around.

### BACKGROUND OF THE INVENTION

Document EP3089176A1 describes an electromagnetic device comprising an elongated magnetic core surrounded by a coil, the magnetic core and the coil being embedded in a waterproof enclosure. This document does not describe how to maintain the magnetic core centered within the mold during the overmolding thereof.

Document US2021376476A1 also describes a similar electromagnetic device in which the magnetic core and the coil are supported in a bobbin introduced in the mold to center the magnetic core during the overmolding operation, but this solution is labor intensive requiring the fabrication and the placement of said bobbin.

Other documents, such documents U.S. Pat. No. 10,893,623B2 (Valeo), EP0472199A1 and other similar documents, describe how to retain an element within a mold using retractile levers integrated in the mold, but this technical solution greatly increases the production and maintenance cost of the mold.

The present invention solves those and other problems.

### DESCRIPTION OF THE INVENTION

According to a first aspect, the present invention concerns to a waterproof electromagnetic device, as defined in claim 1.

Said electromagnetic device can be, for example, an inductor, an antenna, a near field antenna, an electric transformer, among others.

The proposed waterproof electromagnetic device comprises, in a manner already known in the state of the art, the following features:
a magnetic core surrounded by at least one coil;
an electronic circuit board including at least connection pins electrically connected to the at least one coil;
an enclosure overmolded on a waterproof manner surrounding the magnetic core, the surrounding at least one coil and the electronic circuit board;

The overmolding, typically using a plastic or a thermoplastic material, creates a surrounding hard shell which seals all the water channels communicating the interior elements with the exterior of the enclosure, preventing the entrance of water therein and also increasing the structural resistance of the waterproof electromagnetic device, for example against impacts.

The present invention further proposes, in a manner not known from the available state of the art, the inclusion of several protrusions projecting from the magnetic core towards an external surface of the enclosure, providing a centering of the magnetic core within the enclosure during the overmoulding operation.

According to that, the magnetic core includes protrusions extending from the magnetic core, extending through the enclosure, each protrusion including a protrusion tip reaching the external surface of the enclosure.

It will be understood that the external surface of the enclosure is the surface determining its envelope, which is defined by the shape of the mold where it has been injected.

Those protrusions extend preferably from at least two opposed sides of the magnetic core in two opposed directions. It is also preferred to include at least three protrusions on the same side of the magnetic core to provide stability when the magnetic core is inserted in the mold before the overmolding, being then the magnetic core supported on the protrusion tips of those at least three protrusions on the same side of the magnetic core.

The magnetic core is preferably an elongated magnetic core which define a longitudinal direction, in which case the protrusions extend preferably in a radial direction regarding this longitudinal direction.

According to an embodiment of the present invention, the electronic circuit board is partially embedded in the magnetic core, providing a support for the electronic circuit board during the overmolding operation, the magnetic core supporting the electronic circuit board away from the surfaces of the enclosure mold during the overmoulding operation.

Preferably the connection pins of the electronic circuit board are connected to electrically exposed ends of electric cables. The connection pins and the electrically exposed ends of the electric cables will be also embedded in the enclosure and the electric cables will extend outside the enclosure. In that manner, the electromagnetic device signals can we communicated through said cables, and the connection between the cables and the coil is waterproof and has an increased resistance.

According to a second aspect described in claim 9, the present invention is also directed towards a production method for producing a waterproof electromagnetic device.

The proposed method comprises, in a manner already known in the state of the art, the following:
producing a magnetic core surrounded by at least one coil, the at least one coil being connected to connection pins of an electronic circuit board;
inserting the magnetic core, the surrounding at least one coil and the electronic circuit board in an enclosure mold and closing the enclosure mold;
overmoulding within the enclosure mold an enclosure on a waterproof manner surrounding the magnetic core, the at least one coil and the electronic circuit board, obtaining the waterproof electromagnetic device, and extracting the waterproof electromagnetic device from the enclosure mold.

The method also comprises, in a manner not known from the state of the art, the following:
the magnetic core is produced including several protrusions projecting from the magnetic core in radial directions, each protrusion including a protrusion tip which contacts with the enclosure mold when the magnetic core is introduced in the enclosure mold, providing a centering of the magnetic core within the enclosure mold during the overmoulding of the enclosure.

According to that, the magnetic core is produced including protrusions extending from the magnetic core away from said magnetic core, each protrusion defining a protrusion tip on a distal end thereof.

When the magnetic core, and the coil and electric circuit board attached to the magnetic core, are introduced in the enclosure mold, those protrusion tips contact with inner surfaces of the enclosure mold keeping the rest of the magnetic core and the other elements attached thereto away from inner surfaces of the enclosure mold and in a centered position, avoiding its movement during the overmolding operation.

Then, with the enclosure mold closed, the molten material constitutive of the enclosure is injected into the enclosure mold, completely surrounding the elements contained therein except for the protrusion tips, which will be coincident with the external surface of the formed enclosure in those points where the protrusion tips contact with the inner surface of the mold.

To electrically insulate the magnetic core, it is also proposed to optionally cover the protrusion tips with a waterproof and electrically insulating seal, or with a waterproof and electrically insulating seal made of resin, before the insertion of the magnetic core in the enclosure mold or after the extraction of the waterproof electromagnetic device from the mold.

Preferably the magnetic core is an injection molded magnetic core, for example made of composite materials comprising a polymeric matrix with embedded hard magnetic filler particles.

According to an embodiment of the proposed method, to produce the magnetic core a portion of the electronic circuit board is inserted in a core mold, and the magnetic core is produced by molding in said core mold, obtaining a magnetic core with the electronic circuit board attached thereto and partially embedding therein in a position selected to keep the electronic circuit board away from the enclosure mold during the overmolding of the enclosure.

### BRIEF DESCRIPTION OF THE FIGURES

The foregoing and other advantages and features will be more fully understood from the following detailed description of an embodiment with reference to the accompanying drawings, to be taken in an illustrative and non-limitative manner, in which:

FIG. 1 shows a perspective view of the waterproof electromagnetic device, where it is shown the enclosure and the cables exiting said enclosure with an electric connector at one distal end of said cables away from the enclosure;

FIG. 2 shows a perspective view of the waterproof electromagnetic device with the cable routing longitudinal groove;

FIG. 3A shows a transversal cross section of the waterproof electromagnetic device coincident with the protrusions of the magnetic core;

FIG. 3B shows a longitudinal cross section of the waterproof electromagnetic device coincident with the cables exiting the enclosure;

FIG. 4 shows a top view of the same embodiment shown in FIG. 2;

FIG. 5 shows a perspective view of the waterproof electromagnetic device shown in FIG. 2 without the enclosure;

FIG. 6 shows the same waterproof electromagnetic device devoid of enclosure shown in FIG. but from the inverse side.

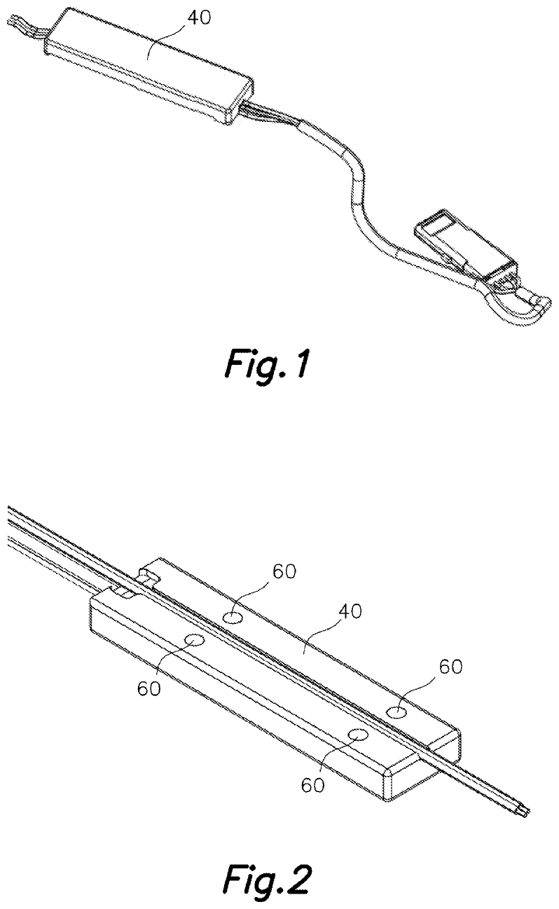

### DETAILED DESCRIPTION OF THE INVENTION AND OF PARTICULAR EMBODIMENTS

According to the preferred embodiment of the present invention, the proposed waterproof electromagnetic device comprises a magnetic core 10 surrounded by at least one coil 20 wounded therearound, an electronic circuit board 30 including at least connection pins 31 electrically connected to the at least one coil 20, and an enclosure 40 overmolded on a waterproof manner surrounding the magnetic core 10, the at least one coil 20 and the electronic circuit board 30.

Typically, the coil 20 will be one coil 20 wound around one X axis of the magnetic core 10, or two coils 20 wound around two orthogonal axis X and Y of the magnetic core 10 or three coils 20 wound around three orthogonal axis X, Y and Z of the magnetic core 10.

The proposed magnetic core 10 further includes several protrusions 11 projecting from the magnetic core 10 towards an external surface of the enclosure 40, so that a centering of the magnetic core 10 within the enclosure 40 is provided during the overmoulding operation.

Preferably the electronic circuit board 30 is partially embedded in the magnetic core 10, so that it is attached thereto during the overmolding of the enclosure, the magnetic core 10 maintaining the position of the electronic circuit board 30 during the overmolding of the enclosure 40.

The connection pins 31 of the electronic circuit board 30 are preferably connected to electrically exposed ends of electric cables 50. In such case, the connection pins 31 and the electrically exposed ends of the electric cables 50 will be also embedded in the enclosure 40, a portion of the electric cables 50 extending outside the enclosure 40. This feature ensures the proper signal transmission and the waterproofing of the connection between the electric cables 50 and the connection pins 31.

According to an embodiment, each electric cable 50 includes a sealing portion 51 not embedded in the enclosure 40. Said sealing portion 51 will be comprised between two portions of the cable embedded in the enclosure 40. Each sealing portion 51 will be covered by a waterproof and electrically insulating seal 60, or by a waterproof and electrically insulating seal 60 made of resin, providing an additional waterproof sealing.

Preferably, the sealing portion 51 of the electric cables 50 are placed in a cavity of the enclosure which is filled with the waterproof and electrically insulating seal 60.

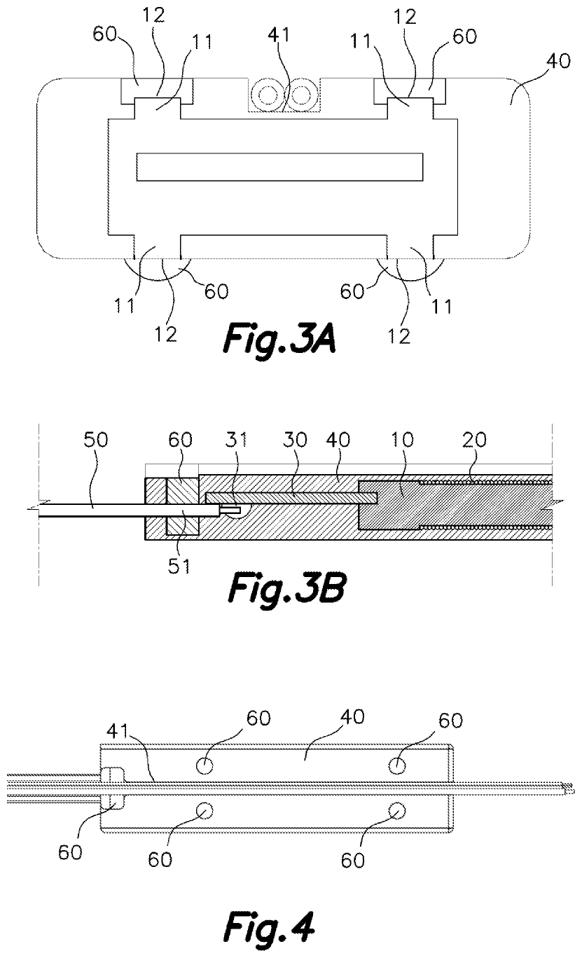

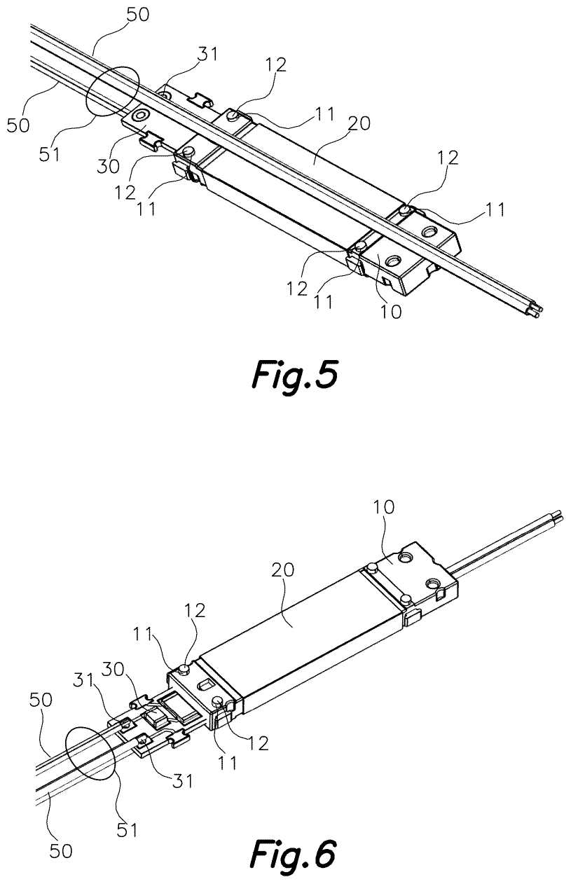

An embodiment of this feature can be seen in FIG. 3B, where the cavity is a blind hole. The inner surfaces of the blind hole define two facing surfaces of the enclosure 40, each cable passing through both facing surfaces defining the sealing portion 51 of the cable between said facing surfaces. The insulating seal 60 fills the blind hole completely surrounding the sealing portion 51.

According to an alternative embodiment, the cavity can be a through hole of the enclosure 40.

Each protrusion 11 defines a protrusion tip 12 on its distal end regarding the rest of the magnetic core 10.

According to an embodiment, the external surface of the enclosure 40 includes depressed regions defining cavities. Optionally, at least some of the protrusion tips 12 of the protrusions 11 will reach the external surface of the enclosure 40 on the depressed regions of the external surface defining the cavities, so that said protrusion tips 12 will be housed within a cavity. In any case, preferably the protrusion tips 12 are covered by waterproof and electrically insulating seal 60, or by a waterproof and electrically insulating seal 60 made of resin.

When the protrusion tips 12 are housed within a cavity of the enclosure, the insulating seal 60 may fill said cavity and also may be flush with the external surface of the enclosure surrounding the cavity, providing a flat enclosure 40. This embodiment can be seen in FIG. 3A (upper side).

According to an alternative embodiment, the protrusion tips 12 are flush with the enclosure 40, in which case the insulating seal 60 may be applied on top of the enclosure 40, producing a bulge. This embodiment can be seen in FIG. 3A (lower side). Preferably both upper and lower sides of the enclosure 40 have the same configuration.

Optionally, the external surface of the enclosure 40 can include a longitudinal groove 41 extending along the entire length of the enclosure 40 for cable routing.

The present invention also proposed a production method for producing a waterproof electromagnetic device such the electromagnetic device described above.

The proposed method comprises producing a magnetic core 10 surrounded by at least one coil 20, the at least one coil 20 being connected to connection pins 31 of an electronic circuit board 30, inserting the magnetic core 10, the surrounding at least one coil 20 and the electronic circuit board 30 in an enclosure mold and closing the enclosure mold, and overmoulding within the enclosure mold an enclosure 40 on a waterproof manner surrounding the magnetic core 10, the at least one coil 20 and the electronic circuit board 30, obtaining the waterproof electromagnetic device. Later, the waterproof electromagnetic device is extracted from the enclosure mold.

The method further proposed to produce the magnetic core 10 including several protrusions 11 projecting from the magnetic core 10 in radial directions, each protrusion 11 including a protrusion tip 12 which contacts with the inner surfaces of the enclosure mold when the magnetic core 10 is introduced in the enclosure mold, providing a centering of the magnetic core 10 within the enclosure mold during the overmoulding of the enclosure 40.

Preferably the enclosure mold includes protruding centering configurations complementary with the protrusion tips 12 which protrude from the inner surface of the enclosure mold. Those protruding centering configurations determine cavities in the external surface of the enclosure 40 once overmolded within the enclosure mold.

In this case, the protrusion tips 12 will contact the enclosure mold in the protruding centering configurations when inserted in the enclosure mold so that, after the overmolding, the protrusion tips 12 will be coincident with the external surface of the enclosure 40 within said cavities.

It is also proposed to cover the protrusion tips 12 with a waterproof and electrically insulating seal 60, for example made of resin, either before the insertion of the magnetic core 10 in the enclosure mold or after the extraction of the waterproof electromagnetic device from the enclosure mold.

When the protrusion tips are coincident with the external surface of the enclosure in said cavities, the waterproof and electrically insulating seal 60 will fill said cavities, obtaining a flush and smooth external surface of the resulting waterproof electromagnetic device.

According to an embodiment, to produce the magnetic core 10, a portion of the electronic circuit board 30 is inserted in a core mold, and the magnetic core 10 is produced by molding in said core mold. As a result, a magnetic core 10 with the electronic circuit board 30 attached thereto and partially embedding therein will be obtained. The position of the electronic circuit board 30 in regard to the magnetic core 10 will be selected to keep the electronic circuit board 30 supported by the magnetic core 10 away from the inner surfaces of the enclosure mold during the overmolding of the enclosure 40.

Preferably, before the insertion of the magnetic core 10 in the enclosure mold, the connection pins 31 are connected to electrically exposed ends of electric cables 50, for example by welding. Later, the magnetic core 10, the at least one coil 20 and the electronic circuit board 30 with the electric cables 50 connected thereto will be inserted in the enclosure mold, the electric cables 50 extending outside the enclosure mold through cable exit openings provided in the enclosure mold. The overmolding operation will then produce the enclosure 40 embedding also the connection pins 31, the electrically exposed end of each electric cable 50 and a portion of each electric cable 50, which is contained within the enclosure mold between the connection pins 31 and the cable exit openings of the enclosure mold, ensuring a proper waterproofing of the connection between the cables and the connection pins 31.

Preferably, the enclosure mold comprises protruding reserves which, when the enclosure mold is closed, cover a sealing portion 51 of each electric cable 50 contained within the enclosure mold preventing the sealing portions 51 to be embedded in the enclosure 40. The protruding reserves are separated from the cable exit openings of the enclosure mold through a distance in which a portion of the electric cables will be overmolded.

In this case, the electric cables 50 are positioned within the enclosure mold positioning a sealing portion 51 of each electric cable 50 in correspondence with the complementary protruding reserves of the enclosure mold, producing an enclosure with a sealing portion 51 of each cable 50 exposed and comprised between two portions of the electric cables embedded in the enclosure 40.

After the extraction of the waterproof electromagnetic device from the enclosure mold, the sealing portion 51 of each electric cable 50 is covered with a waterproof and electrically insulating seal 60 optionally made of resin, improving the waterproofing of the cables.

1. A waterproof electromagnetic device, comprising:
a magnetic core (10) surrounded by at least one coil (20);
an electronic circuit board (30) including at least connection pins (31) electrically connected to the at least one coil (20);
an enclosure (40) overmolded on a waterproof manner surrounding the magnetic core (10), the at least one coil (20) and the electronic circuit board (30);
wherein
the magnetic core (10) further includes several protrusions (11) projecting from the magnetic core (10) towards an external surface of the enclosure (40), so that a centering of the magnetic core (10) within the enclosure (40) is provided during an overmolding operation.

2. The waterproof electromagnetic device according to claim 1, wherein the protrusions (11) extend from at least two opposed sides of the magnetic core (10) in two opposed directions.

3. The waterproof electromagnetic device according to claim 1, wherein the electronic circuit board (30) is partially embedded in the magnetic core (10).

4. The waterproof electromagnetic device according to claim 1, wherein the connection pins (31) are connected to electrically exposed ends of electric cables (50), the connection pins (31) and the electrically exposed ends of the electric cables (50) being embedded in the enclosure (40) and the electric cables (50) extending outside the enclosure (40).

5. The waterproof electromagnetic device according to claim 4, wherein each electric cable (50) includes a sealing portion (51), adjacent to one end of the waterproof electromagnetic device, not embedded in the enclosure (40) and comprised between two portions of the cable embedded in the enclosure (40), each sealing portion (51) being covered by a waterproof and electrically insulating seal (60), or by a waterproof and electrically insulating seal (60) made of resin.

6. The waterproof electromagnetic device according to claim 5, wherein the sealing portion (51) of the electric cables (50) are placed in a cavity of the enclosure, wherein the cavity is filled with the waterproof and electrically insulating seal (60).

7. The waterproof electromagnetic device according to claim 1, wherein protrusion tips (12) of the protrusions (11) reaching the external surface of the enclosure (40) or reaching the external surface of the enclosure (40) and housed in a cavity defined in the external surface of the enclosure (40), are covered by waterproof and electrically insulating seal (60), or by a waterproof and electrically insulating seal (60) made of resin.

8. The waterproof electromagnetic device according to claim 1, wherein the external surface of the enclosure (40) includes a longitudinal groove (41) extending along the entire length of the enclosure (40) for cable routing.

9. A production method for producing a waterproof electromagnetic device, the method comprising:
producing a magnetic core (10) surrounded by at least one coil (20), the at least one coil (20) being connected to connection pins (31) of an electronic circuit board (30);
inserting the magnetic core (10), the surrounding at least one coil (20) and the electronic circuit board (30) in an enclosure mold and closing the enclosure mold;
overmolding an enclosure (40) within the enclosure mold on a waterproof manner surrounding the magnetic core (10), the at least one coil (20) and the electronic circuit board (30), obtaining the waterproof electromagnetic device, and extracting the waterproof electromagnetic device from the enclosure mold;
wherein
the magnetic core (10) is produced including several protrusions (11) projecting from the magnetic core (10), each protrusion (11) including a protrusion tip (12) which contacts with the enclosure mold when the magnetic core (10) is introduced in the enclosure mold, providing a centering of the magnetic core (10) within the enclosure mold during the overmolding of the enclosure (40).

10. The production method according to claim 9, wherein the protrusion tips (12) contact the enclosure mold in protruding centering configurations of the enclosure mold, the protruding centering configurations determining cavities in an external surface of the enclosure (40), so that the protrusion tips (12) are coincident with the external surface of the enclosure (40) within the cavities.

11. The production method according to claim 9, wherein the protrusion tips (12) are covered with a waterproof and electrically insulating seal (60), or with a waterproof and electrically insulating seal (60) made of resin, before the insertion of the magnetic core (10) in the enclosure mold or after the extraction of the waterproof electromagnetic device from the enclosure mold.

12. The production method according to claim 9, wherein to produce the magnetic core (10), a portion of the electronic circuit board (30) is inserted in a core mold, and the magnetic core (10) is produced by molding in the core mold, obtaining a magnetic core (10) with the electronic circuit board (30) attached thereto and partially embedding therein in a position selected to keep the electronic circuit board (30) away from the enclosure mold during the overmolding of the enclosure (40).

13. The production method according to claim 9 wherein, before the insertion of the magnetic core (10) in the enclosure mold, the connection pins (31) are connected to electrically exposed ends of electric cables (50), and later the magnetic core (10), the at least one coil (20) and the electronic circuit board (30) with the electric cables (50) connected thereto are inserted in the enclosure mold, the electric cables (50) extending outside the enclosure mold through cable exit openings of the enclosure mold, the overmolding producing the enclosure (40) embedding also the connection pins (31), the electrically exposed end of each electric cable (50) and a portion of each electric cable (50).

14. The production method according to claim 13, wherein the electric cables (50) are positioned within the enclosure mold positioning a sealing portion (51) of each electric cable (50) in correspondence with protruding reserves of the enclosure mold covering the sealing portion (51) of each electric cable (50) when the enclosure mold is closed, the protruding reserves preventing the sealing portions (51) to be embedded in the enclosure (40), the protruding reserves covering the sealing portion (51) of the electric cables (50) being separated from the cable exit openings of the 5 enclosure mold through a distance in which a portion of the electric cables will be overmolded.

15. The production method according to claim 14, wherein after the extraction of the waterproof electromagnetic device from the enclosure mold, the sealing portion (51) of each electric cable (50) is covered by a waterproof and electrically insulating seal (60), or by a waterproof and electrically insulating seal (60) made of resin.
